(19) United States
(12) Patent Application Publication
(10) Pub. No.: US 2008/0269987 A1
(43) Pub. Date: Oct. 30, 2008

(54) Semi-Active Roll Control System and Control Strategies for Semi-Active Roll Control

(76) Inventors: Richard J. Barron, Ann Arbor, MI (US); James R. Hollowell, Brownstown, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/628,228

(22) PCT Filed: May 17, 2005
(86) PCT No.: PCT/US05/17218

§ 371 Date: Jan. 11, 2008

Related U.S. Application Data
(60) Provisional application No. 60/576,160, filed on Jun. 2, 2004.
(60) Provisional application No. 60/599,376, filed on Aug. 6, 2004.

(51) Int. Cl. G05B 13/00; B60G 21/05

(52) U.S. Cl. 701/38; 280/124.106

(57) ABSTRACT

A roll control actuator, a roll control system, and a roll control strategy for controlling the roll of a motor vehicle are disclosed. The actuator comprises a selective lock connected between an unsprung portion of the vehicle and a sprung portion of the vehicle. The system comprises such an actuator. The strategy comprises utilizing locking and unlocking thresholds to control the locked state of such an actuator.

### CROSS-REFERENCE TO RELATED APPLICATIONS

This application claims the benefit of U.S. Provisional Application No. 60/576,160, filed Jun. 2, 2004, the disclosure of which is incorporated herein by reference.

This application claims the benefit of U.S. Provisional Application No. 60/599,376, filed Aug. 6, 2004, the disclosure of which is incorporated herein by reference.

### BACKGROUND OF THE INVENTION

This invention relates in general to motor vehicle roll control systems and in particular to a self-centering actuator for a roll control system, and a roll control system including a self-centering actuator, and methods of operating a roll control system with a self-centering actuator.

Suspension systems for a motor vehicle are known which isolate the vehicle load from irregularities in the terrain over which the vehicle travels. A semi-active suspension system, for example, normally includes a spring and a damper connected between the sprung and unsprung portions of the vehicle. Semi-active suspension systems are generally self-contained, and only react to the loads applied to them. In active suspension systems, by contrast, the reactions to the applied loads are positively supplied typically by electronically controlled hydraulic or pneumatic actuators.

In addition to isolating the sprung portion of the vehicle from the road, it is desirable to stabilize the tendency of the sprung portion of the vehicle to tilt or roll relative to its unsprung portion when accelerating, decelerating or cornering at relatively high rates. Therefore, suspension systems have been proposed to maintain the vehicle in an essentially level position, regardless of the source of the force seeking to upset that position. For example, U.S. Pat. No. 5,630,623 to Ganzel, the disclosures of which are incorporated herein by reference, discloses a semi-active system for controlling the roll of a motor vehicle including an actuator connected between an unsprung portion of the vehicle and a sprung portion of the vehicle. The known roll control system not only locks and unlocks the anti-roll bars of the vehicle (i.e. controls the locked state), but also accommodates the upward or downward deflections of any of the four wheels of the vehicle, regardless of whether the affected wheel is on the inside or outside of the turn, as will be described in more detail below.

Referring now to the drawings, FIGS. 1 and 2 show a prior art semi-active, pumpless system 10 for controlling the roll of a motor vehicle. The system 10 comprises an actuator 12, first and second pressure control or pressure relief valves 14 and 16, and first and second check valves 18 and 20. A second rear actuator 21 and corresponding hydraulic circuit are also provided. Each of the actuators 12 and 21 includes a cylinder 42 and a piston 44 reciprocably disposed in the respective cylinder 42.

Each of the wheels 22, 24, 26 and 28 of the vehicle is rotationally mounted about a substantially horizontal axis to a member such as suspension arms 30, 32, 34 and 36, respectively, which form part of an unsprung portion of the vehicle. The unsprung portion of the vehicle is in turn connected to a sprung portion of the vehicle through the actuators 12 and 21 and anti-roll or anti-sway bars 38 and 40.

One of the cylinder 42 or the piston 44 of each actuator 12, 21 is drivingly connected to an associated one of the anti-roll bar 38, 40 or the suspension arm 30, 32, 43, 36 while the other component of each cylinder/piston pair is drivingly connected to the associated other of the anti-roll bar 38, 40 or the suspension arm 30, 32, 43, 36. As shown in FIGS. 1 and 2, for example, the cylinder 42 of the front actuator 12 is connected to one free end of the front anti-roll bar 38, while the portion of the piston rod extending generally downwardly from the cylinder is connected to the front right suspension arm 30. Similarly, the rear anti-roll bar 40 is coupled to the cylinder 42 of the right rear actuator 21 while the piston 44 of the actuator 21 is connected to the suspension arm 32.

The actuators 12 and 21 each have a pair of ports, respectively 46, 48 and 50, 52, through which a working medium such as hydraulic fluid may be alternately provided to or evacuated from the ends of the cylinders 42 disposed on either side of the pistons 44 situated therein. As described more fully below, each of the actuators 12 and 21 serves to maintain the sprung height from the road surface of the portion of the vehicle body above its associated wheel.

The first pressure control valve 14 is a proportional relief valve, and is in communication with the first port 46 of the actuator 12 through a hydraulic line 54. The valve 14 is operated by a proportional solenoid, and has an open position and a closed position. In response to actual or anticipated loading of the actuator 12, the solenoid energizes the valve 14 toward the closed position with a force proportional to an electric signal applied thereto, which prevents flow away from the first port 46 until a predetermined pressure develops in the upper chamber of the cylinder 42 to overcome the solenoid force, as described more fully below. The first check valve 18 is situated in the hydraulic circuit in parallel with the first pressure control valve 14, and permits flow therethrough only in a direction toward the first port 46 of the actuator 12.

The second pressure control valve 16 is also a proportional relief valve, and is in communication with the second port 48 of the actuator 12 through a hydraulic line 56. The valve 16 is also controlled by a proportional solenoid, and can be moved between open and closed positions by the solenoid to prevent flow away from the second port 48 until a predetermined pressure develops in the lower chamber of the cylinder 42. The second check valve 20 is situated in the hydraulic circuit in parallel with the second pressure control valve 16 and permits flow therethrough only toward the second port 48 of the actuator 12.

A hydraulic circuit for the rear actuator 21 is also provided and is substantially identical to the hydraulic circuit for the front actuator 12. Thus, a proportional pressure control valve 58 and a parallel check valve 60 are provided in communication with the first port 50 of the rear actuator 21, and another proportional pressure control valve 62 and a parallel check valve 64 are provided in communication with the second port 52 of the rear actuator.

In operation, an electronic control unit (ECU) 70 processes inputs from one or more wheel speed sensors 72, a lateral accelerometer 74, and a steering angle sensor 76. Given these inputs, the ECU predicts the severity of an upcoming roll, and issues control, commands to the solenoids of the appropriate valves 14 and 58 or 16 and 62. For example, the motor vehicle may begin a relatively high speed left hand turn, which in absence of compensation by the system 10 would cause the unsprung portion of the vehicle to tend to roll generally clockwise about it longitudinal axis.

At the beginning of such a maneuver, sensors 72, 74 and 76 signal the instantaneous conditions to the ECU 70. The ECU in turn calculates or obtains from a look up table the net pressure P that needs to be developed in the upper chambers of the cylinders 42 of one or both of the actuators 12 and 21 to counteract the vehicle roll, and energizes the solenoids of the pressure control valves 14 and 58 an amount sufficient to resist flow through those valves up to the pressure P.

To counteract anticipated vehicle roll in the opposite direction, for example as might be experienced during a right hand turn, the ECU 70 repeats this procedure and energizes the solenoids of the valves 16 and 62 to allow build up of the pressure in the lower chambers of both actuator 12 and 21. In either case, as the sensors 72, 74 and 76 indicate an instantaneous or anticipated reduction or increase in the need for counteracting vehicle roll, the ECU signals the appropriate pressure control valves to correspondingly reduce or increase their pressure cut out limit.

If an unexpected load is imposed on one of the actuators, such as might occur when one wheel rolls over a bump in the road, an increased pressure is developed in one chamber of the affected actuator. For example, if the right front wheel 22 encounters a bump and deflects upwardly during a left hand turn, the piston 44 is displaced upwardly in the cylinder 42 and the pressure in the upper chamber of the actuator 12 increases. Even if the valve 14 is closed at this time, the increased pressure overcomes the solenoid force, allowing the suspension to compress and maintain ride quality. As the wheel 22 then passes over the top of the bump and the valve 14 closes again, the check valve 18 allows the piston 44 and the suspension arm 30 to fall back down near their original positions without any resistance from the roll control system. This process takes a finite amount of time, during which the vehicle body will likely roll to some extent, and therefore the piston 44 and the suspension arm 30 are unlikely to return entirely to their original positions.

In the event that the inside wheel 28 suddenly rises while the valve 14 is energized, the suspension arm 36 and the anti-roll bar 38 translate this force and extend the cylinder 42, reducing the pressure in the upper chamber of the actuator 12. If this pressure drops below the pressure in pre-charged accumulator 78, the check valve 18 allows flow into the upper chamber of the actuator 12 so that the anti-roll bar 38 may move to a new position without resistance from the roll control system. This new position may be near the original position or beyond. For example, if the anti-roll bar 38 were originally in a center or neutral position and the valve 14 is energized with the anti-roll bar 38 out of the original position, when the anti-roll bar 38 moves into a new position that new position may be near the original position or past, i.e. past the central or neutral position. It is advantageous in this system to employ a relatively stiff anti-roll bar to facilitate this process.

The accumulator 78 is situated in each of the front and rear hydraulic circuits in communication with the pressure control valves 14, 16 and 58, 62. By maintaining the fluid in the hydraulic circuits under a certain pressure, the accumulator 78 functions to prevent cavitation in the system 10 when the wheels of the vehicle deflect, and also acts as a reservoir to replenish any fluid lost by the system to leakage past dynamic seals. All of the valves and the accumulator for each of the front and rear hydraulic circuits are packaged in units 80 and 82 mounted near the anti-roll bars 38 and 40. The front and rear hydraulic circuits are kept separate so that the valves of each circuit can ride with their respective anti-roll bar, which eliminates the need for running expensive flexible hydraulic hoses from the body of the vehicle to the bar.

### SUMMARY OF THE INVENTION

The present invention includes an actuator for controlling the roll of a motor vehicle. The actuator is connected between an unsprung portion of the vehicle and a sprung portion of the vehicle for selectively coupling the sprung portion of the vehicle to the unsprung portion of the vehicle. In one embodiment, the actuator is a hydraulically operated actuator including a piston fixed to one of the sprung portion of the vehicle and the unsprung portion of the vehicle and a cylinder fixed to the other of the sprung portion of the vehicle and the unsprung portion of the vehicle. The cylinder has an internal surface defining a bore and at least first and second ports. The piston is disposed in the bore of the cylinder between the first and second ports and sealingly engages the internal surface of the cylinder. The first and second ports are connected by a fluid conduit that is one of external to the bore or defined through the piston. A volume of hydraulic fluid is disposed in the bore of the cylinder, such that when flow of the hydraulic fluid between the first port and the second port through the fluid conduit is prevented, the piston can only move in a direction toward a neutral position in the cylinder.

Accordingly, the present invention provides a semi-active roll control system including the actuator described above which allows the vehicle suspension members to return to their neutral position when an external load is imposed on them when the roll control system is functioning.

The present invention also includes a roll control strategy for controlling the roll of a motor vehicle. The strategy comprises utilizing locking and unlocking thresholds to control the locked state of a roll control actuator.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view of a known for controlling the roll of a motor vehicle.

FIG. 2 is another schematic view of the roll control system shown in FIG. 1.

FIG. 3 is a schematic view of a first embodiment of a roll control system according to the present invention.

FIG. 3a is another schematic view of the roll control system shown in FIG. 3.

FIG. 4 is a schematic view of a second embodiment of a roll control system according to the present invention.

FIG. 5 is a schematic view of a third embodiment of a roll control system according to the present invention.

FIG. 6 is a cross-sectional view of the check valve arrangement for use in the roll control system of FIG. 5.

FIG. 7 is a schematic view of a fourth embodiment of a roll control system according to the present invention.

FIG. 8 is a schematic view of a fifth embodiment of a roll control system according to the present invention.

FIG. 9 is a schematic view of a sixth embodiment of a roll control system according to the present invention.

FIG. 10 is a flow chart of method for roll control according to the present invention.

### DETAILED DESCRIPTION OF THE PREFERRED EMBODIMENTS

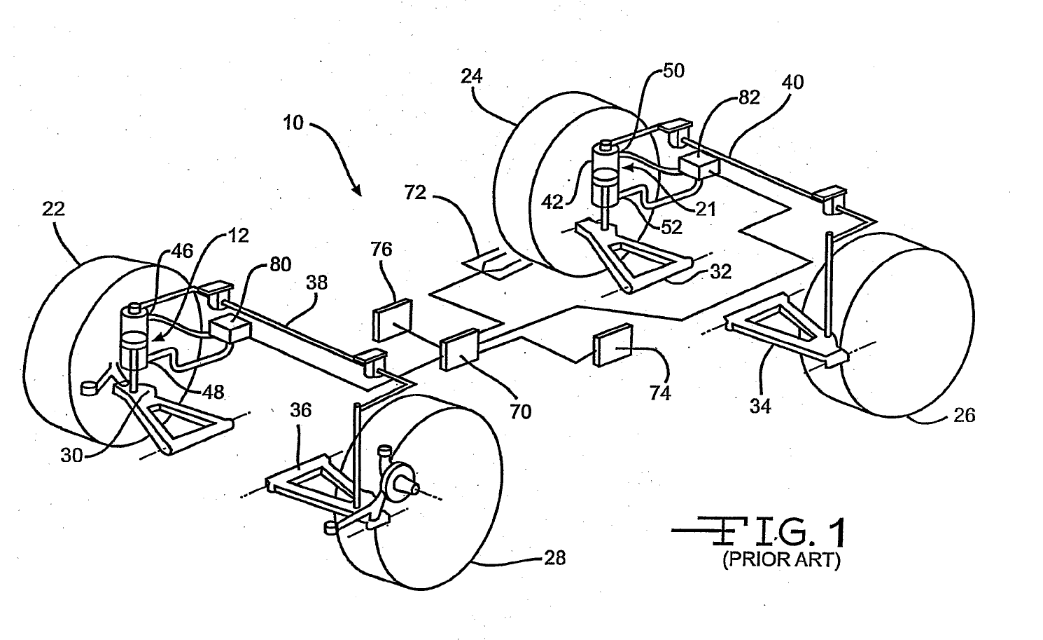

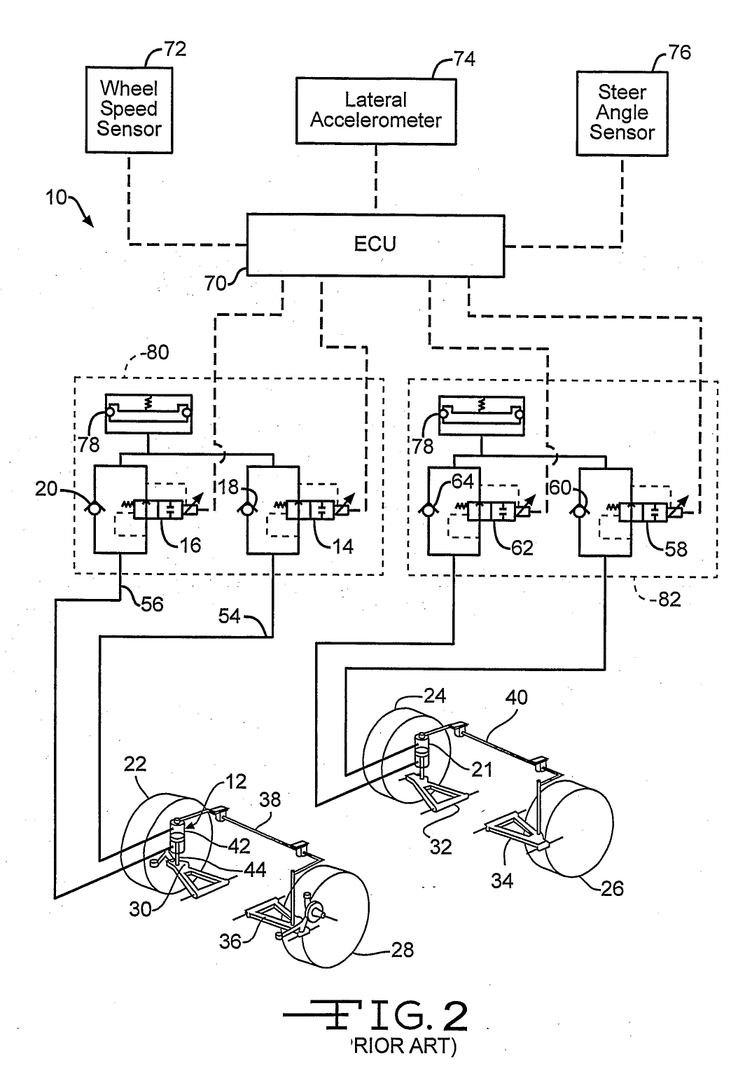

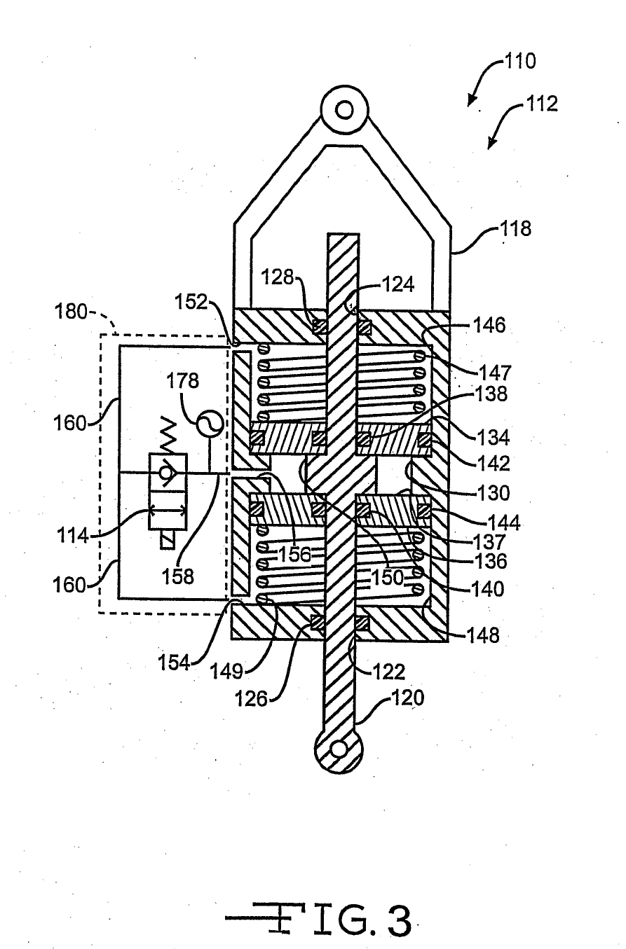

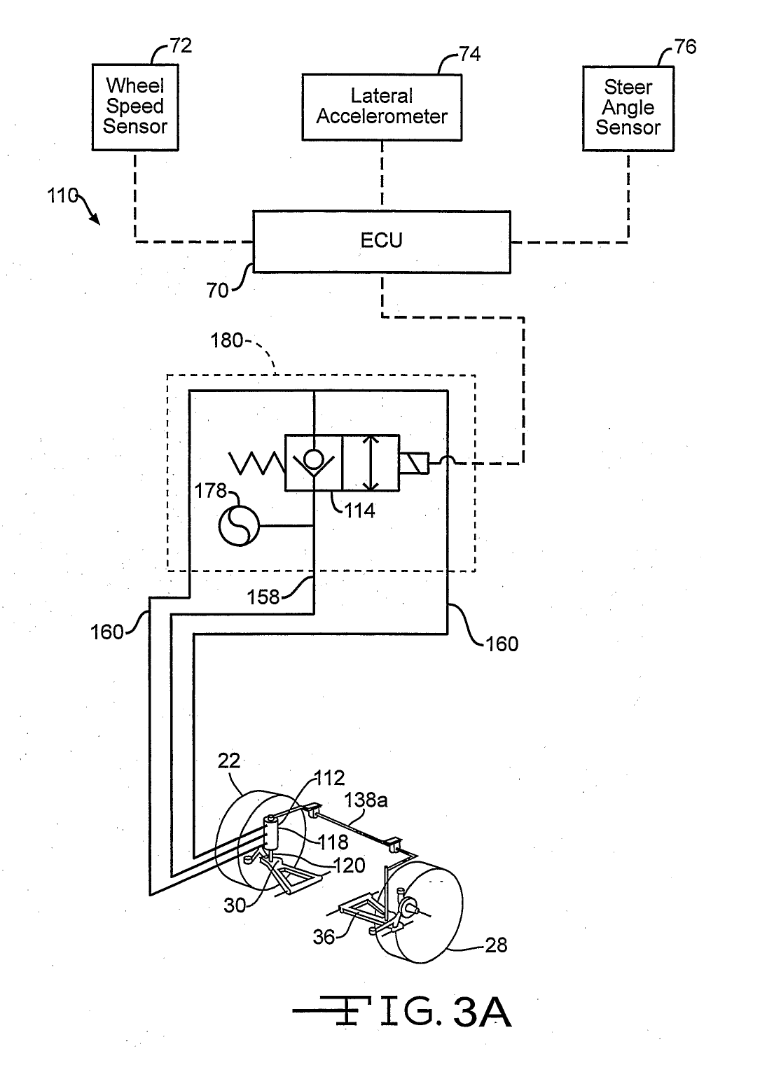

Referring again to the drawings, FIGS. 3 and 3a illustrate a roll control system, indicated generally at 110, in accordance with the present invention, and similar components, as to FIGS. 1 and 2, are labeled with the same numbers. The roll control system 110 comprises an actuator 112, a check valve arrangement 114, and an accumulator 178. The check valve arrangement 114, and the accumulator 178 are preferably packaged in a units 180 and is mounted near the anti-roll bars 38. However, the unit 180 may be mounted near the actuator 112 or in any other suitable location. The invention will be described for a single actuator 112 and hydraulic circuit. However, it is to be understood that, as described above for the prior art roll control system, a second, rear actuator and corresponding hydraulic circuit would also be provided. The roll control system 110 may be used in a vehicle in a manner similar to that described and illustrated in FIGS. 1 and 2 for the prior art roll control system.

The actuator 112 is provided for use similar to that described above for the prior art actuators 12 and 21. The actuator 112 includes a cylinder 118 and a rod 120 disposed in the cylinder 118. One of the cylinder 118 or rod 120 of each actuator is drivingly connected to one of the anti-roll bar 38 and the suspension arm 30, while the other of the cylinder/piston pair is drivingly connected to the other of the anti-roll bar 38 and the suspension arm 30, as described above with respect to FIG. 1 for the prior art roll control system.

The rod 120 extends through a first opening 122 and a second opening 124 in the chamber of the cylinder 118 and is mounted for reciprocal movement therein between a first seal 126 and a second seal 128 disposed within the first opening 122 and the second opening 124, respectively. The cylinder 118 includes an annular flange 130 extending inwardly into the hollow chamber of the cylinder 118. The rod 120 includes an annular flange 132 that extends outwardly into the hollow chamber of the cylinder 118 such that the rod 120 may reciprocate within the cylinder 118 without the annular flange 132 contacting the annular flange 130. A first annular piston 134 is disposed within the cylinder 118 on one side of the annular flange 130 and the annular flange 132 surrounding the rod 120, and a second annular piston 136 is disposed within the cylinder 118 on the other side of the annular flange 130 and the annular flange 132 also surrounding the rod 120. The first and second pistons 134, 136 may each include inner sealing members 138, 140, respectively, and outer sealing members 142, 144, respectively. The first and second pistons 134, 136 cooperate to divide the hollow chamber of the cylinder 118 into an upper chamber 146, a lower chamber 148, and a center chamber 150. Each of the upper chamber 146 and lower chamber 148 has a spring 147, 149, respectively, disposed therein. The springs 147, 149 urge the pistons 134, 136, respectively, toward the annular flange 130.

The upper chamber 146, the lower chamber 148, and the center chamber 150 of the cylinder 118 each have an associated port, 152, 154, and 156, through which a working medium such as hydraulic fluid may be alternatively supplied or released from the associated chamber 152, 154, or 156 of the cylinder 118. The check valve arrangement 114 is in communication with the port 156 of the actuator 112 through a hydraulic line 158 and with the ports 152, 154 through a hydraulic line 160. The accumulator 178 is in fluid communication with the hydraulic line 158 between the check valve arrangement 114 and the port 156.

The check valve arrangement 114 is operated by a solenoid, and has an open position and a check position. When the check valve arrangement 114 is de-energized, it is in the check position, and the check element of the check valve arrangement 114 permits flow through the check valve arrangement 114 in the direction from the hydraulic line 158 to the hydraulic line 160 (i.e. from the port 156 to the ports 152 and 154) and prevents fluid flow through the check valve arrangement 114 in the opposite direction of flow. Except when roll control is desired (i.e. when operating the vehicle along a relatively straight path), the solenoid of the check valve arrangement 114 is energized while the vehicle is in operation. When energized, the check valve arrangement 114 is in the open position such that the check valve arrangement 114 permits flow therethrough in either direction, and thus fluid can flow in a direction from the ports 152, 154 toward the port 156 with the check valve arrangement 114 in the open (energized) position. The rod 120 and the pistons 134, 136 can move freely through the respective chambers 146 and 148, because as the pistons 134, 136 displace fluid from the chambers 146, 148, the fluid may enter the center chamber 150. Conversely, fluid displaced from the center chamber 150 may enter the chambers 146, 148. In response to actual or anticipated loading of the actuator 112, the solenoid is de-energized so that the check valve arrangement 114 moves to the check position. It will be appreciated that the check valve arrangement 114 may be comprised of any valve arrangement that is capable of performing the functions described above. The check valve arrangement 114 may include a check valve and a bypass valve. The status of the bypass valve can be determined by any suitable method. One such method is to inductively measure the air gap via the drive circuit behavior, as described in U.S. Pat. No. 6,577,133 to Barron, the disclosures of which are incorporated herein by reference.

In response to actual or anticipated loading of the actuator 112, the check valve arrangement 114 is de-energized and fluid may be released from the center chamber 150, but cannot be supplied to the center chamber 150 from the chambers 146, 148 as described above. The rod 120 is prevented from further movement away from the center of the cylinder 118, because to move further from the center of the cylinder 118, the fluid in the upper chamber 146 if, for example, the actuator 112 is compressed, must flow out of the port 152. However, no flow path into the chamber 150 for such flow exists if the check valve 114 is in the check position. Fluid also cannot flow into the chamber 148, because the piston 136 is against the flange 130 and cannot move to expand the volume of the chamber 148. Fluid flow is similarly prevented from the chamber 148 if the rod 120 attempts to move away from the center if the actuator 112 is subjected to forces tending to elongate the actuator 112. However, the rod 120 is free to move toward the center of the cylinder 118 when the check valve arrangement 114 is de-energized. When the rod 120 moves toward the center of the cylinder 118, the respective one of the pistons 134, 136 is pushed toward the center of the cylinder 118 by the associated springs 147, 149, and the fluid in the chamber 150 flows through the check valve 114 to the chamber 146 or the chamber 148 on the other side of the moving pistons 134, 136. The other of the pistons 134, 136 remains seated against the annular flange 130.

Unlike the prior art roll control system, when activated, the roll control system 110 allows the rod 120 to move toward the center of the cylinder 118, while preventing the rod 120 from moving away from the center of the cylinder 118. Therefore, the anti-roll bar is locked in position such that the anti-roll bar cannot move in a direction away from the center, or neutral position, but can return to the center or neutral position.

The accumulator 178 is communicably connected to the hydraulic line 158 between the port 156 and the check valve arrangement 114. The accumulator is provided to compensate for any amount of fluid that leaks out of the system over the life of the accumulator 178 and to account for density changes due to temperature changes. The accumulator 178 is preferably a low pressure accumulator operating at a pressure of about 2 bar to about 5 bar.

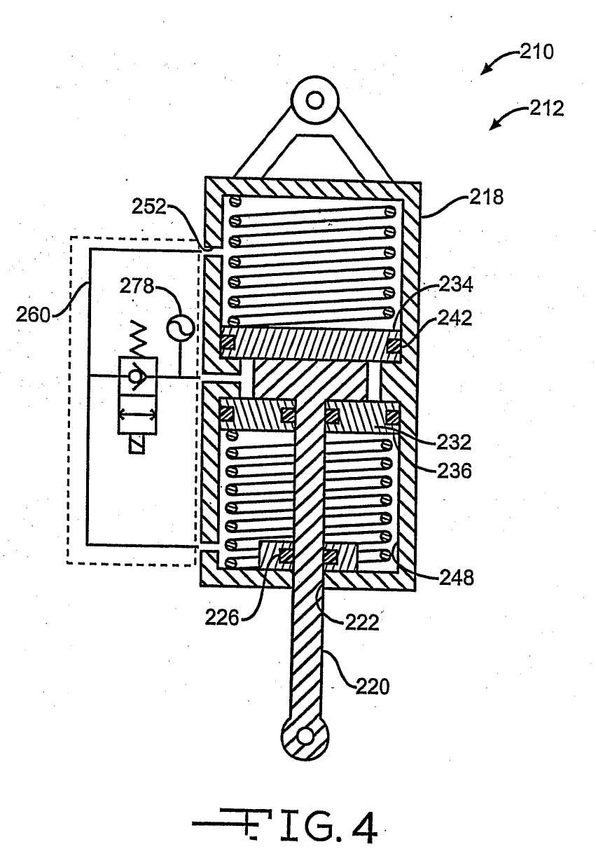

Referring now to FIG. 4, there is illustrated a second embodiment of a roll control system, indicated generally at 210, in accordance with the present invention. The roll control system 210 is similar to the roll control system 110, and similar elements therein have been numbered using corresponding numbers incremented by ‘100’. Only those elements of the roll control system 210 that differ from the elements described for the roll control system 110 will be described. The invention will be described for a single actuator 212 and hydraulic circuit. However, it is to be understood that, as described above, a second, rear actuator and corresponding hydraulic circuit would also be provided. The roll control system 210 may be used in a vehicle in a manner similar to that described above for the first embodiment.

The rod 220 extends through an opening 222 in the cylinder 218 into the chamber of the cylinder 218 and is mounted for reciprocal movement therein between a seal 226 disposed within the opening 222. Unlike the rod 120 of the prior embodiment, the rod 220 does not extend through a second opening in the cylinder 218. Thus, the exterior seals required in the cylinder 218 are reduced to one, namely seal 226.

On the end of the rod 220 disposed within the cylinder 218, the rod 220 includes an annular flange 232 that extends outwardly into the hollow chamber of the cylinder 218 such that the rod 220 may reciprocate within the cylinder 218 without the annular flange 232 contacting the annular flange 230. A first piston 234 is disposed within the cylinder 218 on one side of the annular flange 230 and the annular flange 232, and a second annular piston 236 is disposed within the cylinder 218 on the other side of the annular flange 230 and the annular flange 232 surrounding the rod 220. The first piston 234 is not an annular member, as was the first piston 134, because the rod 220 is not disposed through the first piston 234. The first piston 234 may include an outer sealing member 242. The second piston 236 is similar to the second piston 236, and the first and second pistons 234, 236 cooperate to divide the hollow chamber of the cylinder 218 into an upper chamber 246, a lower chamber 248, and a center chamber 250 in a similar manner as described for the system 110.

Because a varying portion of the rod 220 may extend into the cylinder 218, the volume within the cylinder 218 occupied by the rod 220 varies. Therefore, the accumulator 278 must compensate not only for change in fluid pressure due to the loss in fluid due to leakage from the system 210, but also the potential change in volume within the system 210 due to the movement of a portion of the rod 220 in and out of the closed system of the cylinder 218 of the system 210.

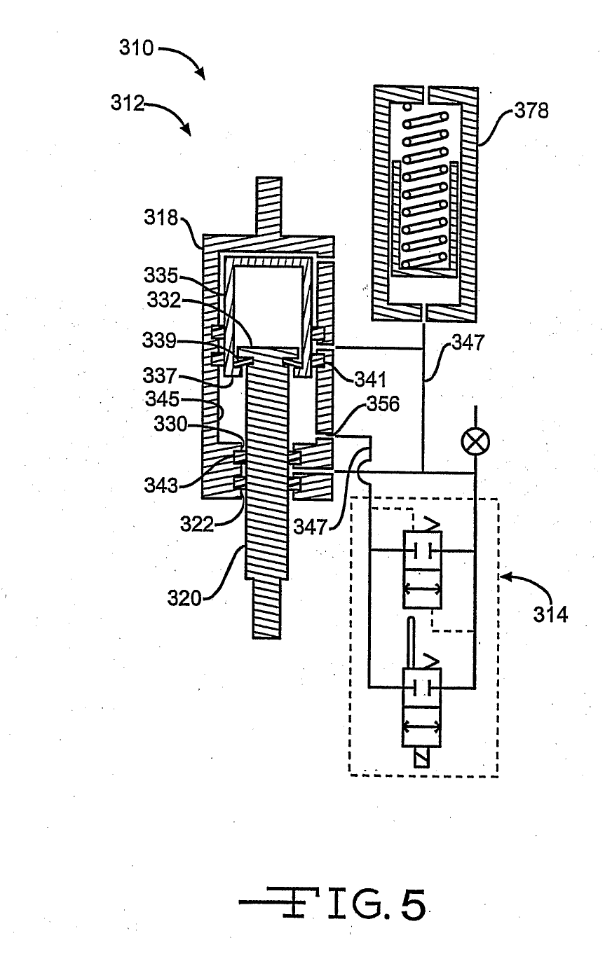

Referring now to FIG. 5, there is illustrated a third embodiment of a roll control system, indicated generally at 310, in accordance with the present invention. The roll control system 310 is similar to the roll control system 110, and similar elements therein have been numbered using corresponding numbers incremented by ‘200’. Only those elements of the roll control system 310 that differ from the elements described for the roll control system 110 will be described. The invention will be described for a single actuator 312 and hydraulic circuit. However, it is to be understood that, as described above, a second, rear actuator and corresponding hydraulic circuit would also be provided. The roll control system 310 may be used in a vehicle in a manner similar to that described above for the first embodiment.

The rod 320 extends through an opening 322 in the cylinder 318 into the chamber of the cylinder 318 and is mounted for reciprocal movement therein between a seal 226 disposed within the opening 322. Unlike the rod 120 of the first embodiment, the rod 320 does not extend through a second opening in the cylinder 318. Thus, only one exterior seal is required the opening 322.

On the end of the rod 320 disposed within the cylinder 318, the rod 320 includes an annular flange 332 that extends outwardly into the hollow chamber of the cylinder 318. A cup-shaped piston 335 is disposed within the cylinder 318 so that the piston 335 opens toward the rod 320. The rod 320 extends into the piston 335 such that the annular flange 332 is disposed within the piston 335. The piston 335 includes an annular flange 337 that extends inwardly into the chamber of the cylinder 318. The annular flange 337 retains the annular flange 332 of the rod 320 within the piston 335. An annular cushion 339 may be provided between the annular flange 337 and the annular flange 332, although such is not required. The annular cushion 339 may be a Bellville washer. It will be appreciated that a similar annular cushion may be adapted for use in the other embodiments described herein even though such a cushion may not be shown.

The cylinder 318 and a first seal 341 and a second seal 343 define a fluid chamber 345 within the cylinder 318. A port 356 is provided in the cylinder 318 to communicably connect the chamber 345 with the check valve arrangement 314 and the accumulator 378 via a hydraulic line 347. As illustrated, the rod 320 and the piston 335 are in the neutral position relative to the cylinder 318. When the check valve arrangement 314 is energized, the rod 320 and the piston 335 may freely reciprocate within the cylinder 318 as needed. The movement of the rod 320 and the piston 335 may displace fluid from the chamber 345. The displaced fluid is stored in the accumulator 378. When the check valve arrangement 314 is de-energized, e.g. the roll control system 310 is engaged, the rod 320 and piston 335 are locked relative to the cylinder 318 such that the rod 320 cannot extend further into the piston 335 and the piston 335 cannot move lower into the chamber 345. However, fluid may flow from the accumulator into the chamber 345, if the fluid pressure within the accumulator is greater than the fluid pressure within the chamber 345. Thus, the rod 320 and the piston 335 will be allowed to return to the neutral position, if either is not in the neutral position when the check valve arrangement is de-energized.

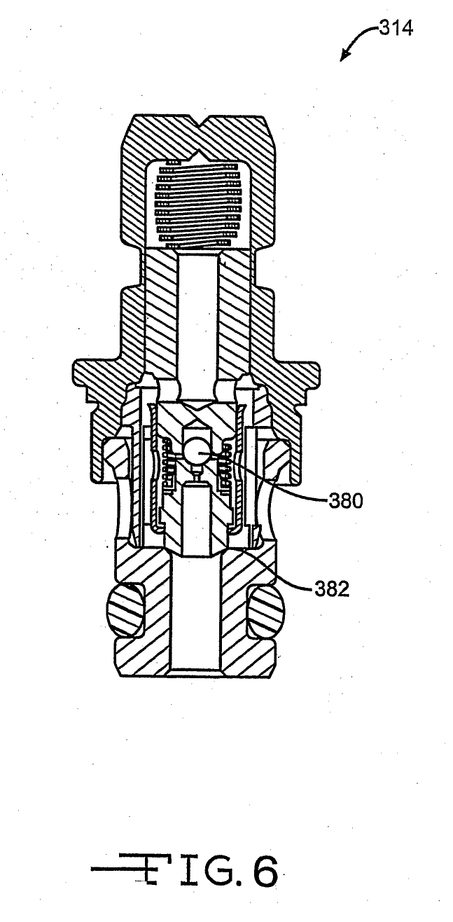

The check valve arrangement 314 performs the same general function of the check valve arrangement 114. However, the check valve arrangement 314 additionally provides for a controlled release of pressure when the check valve arrangement 314 is switched from a de-energized to an energized state. FIG. 6 illustrates an embodiment of the check valve arrangement 314.

The accumulator 378 is illustrated as a conventional low pressure spring accumulator, although such is not required. It will be appreciated that any accumulator suitable for the use described herein, and any of the accumulators shown or described herein may be used in any of the embodiments of the invention. Similar to the operation described above in regard to the second embodiment, because a varying portion of the rod 320 may extend into the cylinder 318, the volume within the cylinder 318 occupied by the rod 320 varies. Therefore, the accumulator 378 must compensate not only for change in fluid pressure due to the loss in fluid due to leakage from the system 310, but also the potential change in volume within the system 310 due to the movement of a portion of the rod 320 in and out of the closed system of the cylinder 318 of the system 310. Additionally, the accumulator 378 is illustrated as a spring accumulator. As described above, if the pressure within the accumulator is higher than that of the pressure within the chamber 345, fluid from the accumulator 378 may feed into the chamber 345 through the check valve arrangement 314, even when the check valve arrangement 314 is de-energized. The inclusion of a spring within the accumulator 378 adjusts the pressure within the accumulator 314 so that the pressure difference between the accumulator 378 and the chamber 345 is detectable.

An embodiment of the check valve arrangement 314 is illustrated in FIG. 6. The check valve arrangement 314 has a restrictive passageway 380 that is opened to decrease the differential pressure across the valve. Once the pressure has decreased such that the pressure exerted on the valve is less than the electromagnetic force exerted on the valve, a secondary passageway 382 is opened. In this manner, there is a controlled release of the differential pressure.

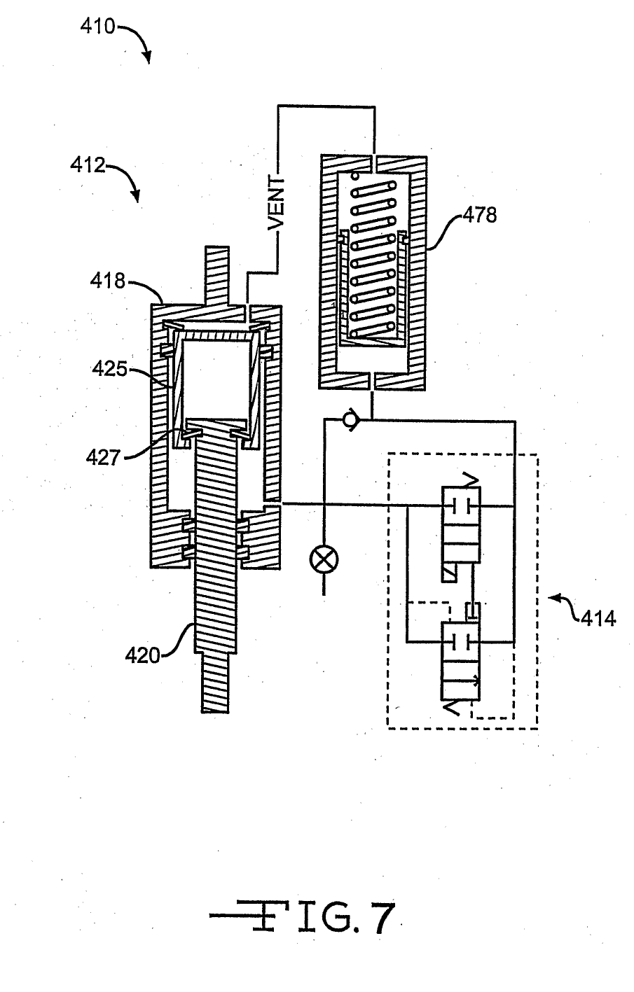

Referring now to FIG. 7, there is illustrated a fourth embodiment of a roll control system, indicated generally at 410, in accordance with the present invention. The roll control system 410 is similar to the roll control system 310.

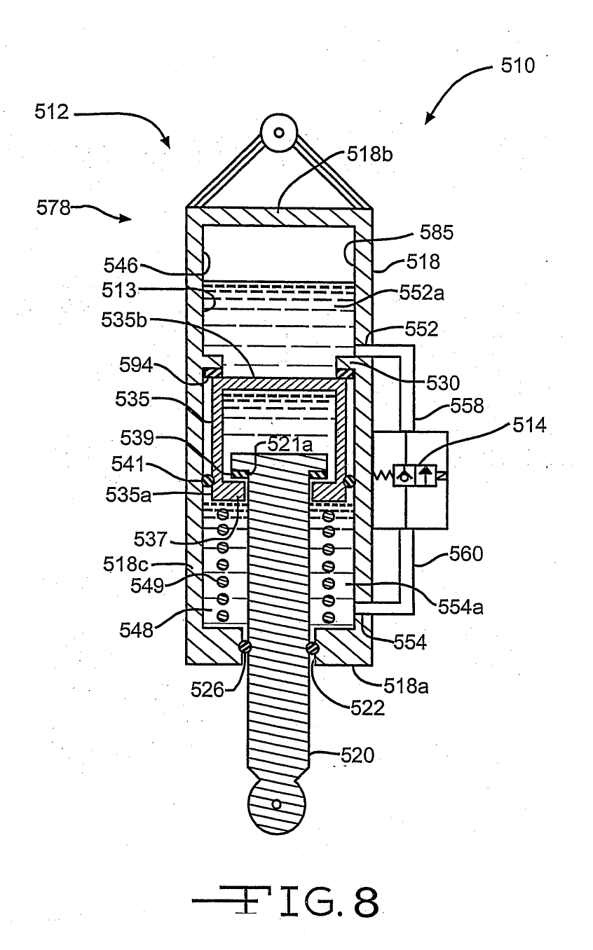

Referring now to FIG. 8, there is illustrated a fifth embodiment of a roll control system, indicated generally at 510, in accordance with the present invention. The roll control system 510 is similar to the roll control system 310. The actuator 512 has an integrated strut with a gas spring to act as the low pressure accumulator as described in the prior embodiment. The actuator 512 does not have any vents to atmosphere. The actuator has an upper chamber 585 that is partially filled with oil with the remaining volume filled with gas.

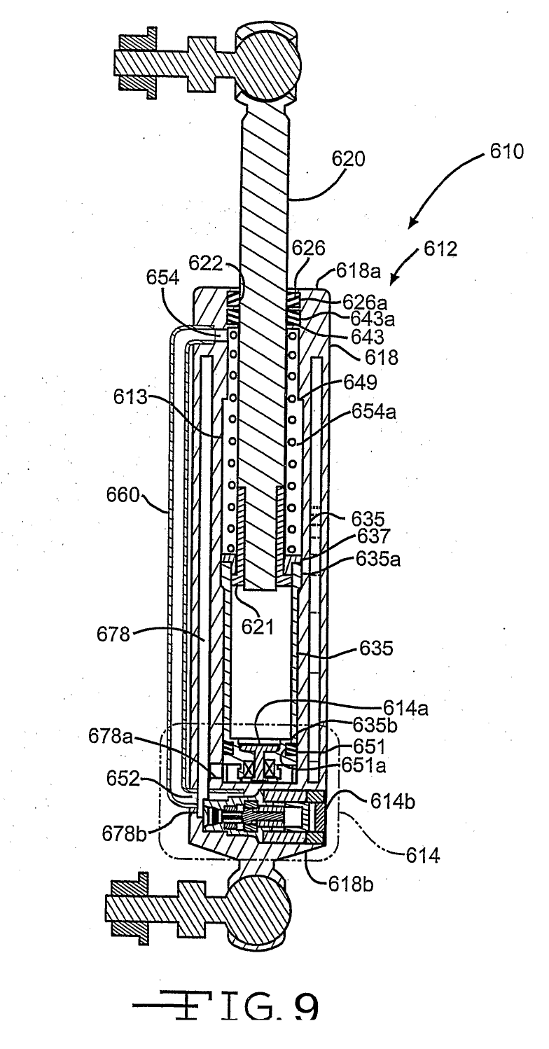

Referring now to FIG. 9, there is illustrated a sixth embodiment of a roll control system, indicated generally at 610, in accordance with the present invention. An actuator 612 has an integrated accumulator 678 that is partially filled with oil with the remaining volume filled with gas. A check valve arrangement 614 is provided in the form of a cartridge valve, although such is not required. The check valve arrangement 614 operates as described in the earlier embodiments. A check valve 691 opens to allow fluid to move between the chamber of the cylinder 618 and the accumulator 678 to return the rod 620 and piston 635 to the neutral position as shown when the check valve arrangement is de-energized.

It will be appreciated that the third, fourth, fifth, and sixth embodiments operate optimally when the respective piston is drivingly connected to the suspension arm of the vehicle and the cylinder is connected to the anti-roll bar of the vehicle.

An alternative embodiment of the present invention includes an actuator that is snubbed or dampened at end of stroke. Any suitable form of dampening may be provided. For example, in a roll control actuator having a piston reciprocating in a cylinder, as the piston approaches end of stroke, part of the piston engages into the cylinder with a small clearance, through which trapped fluid can escape past the piston, for example through radial clearances or a separate restricted flow path, acting to snub or dampen the last portion of travel, and, in addition to other benefits, avoiding a knocking sound and acting to smooth out the ride. Additionally, or alternatively, some resilient material may also be provided to snub or dampen the last portion of travel.

Although various embodiments of the present invention have been described in linear function, it must be understood, however, that the present invention contemplates rotary versions. For example, the linear aspects of the aforementioned embodiments can be replaced with rotary aspects, and the present invention includes embodiments including a rotary actuator.

In addition to the embodiments described above further embodiments of the present invention, include systems and methods (i.e., strategies) for controlling the systems and actuators described above. For example, another alternative embodiment of the present invention includes a control strategy in which front and rear actuators may be selectively locked and unlocked independently of each other, i.e. locked and unlocked in phase or out of phase, i.e. the front and rear actuators may be locked and unlocked at different times. For example, the front and rear actuators may be locked and unlocked out of phase to bend or to modify the roll moment distribution of the vehicle between front and rear, affecting an over or under steer of the vehicle. As another example, vehicle trajectory may be adjusted during yaw and side slip conditions, by selectively locking the roll control actuator to modify over steer or under steer. In this example, locking rear with front unlocked causes over steer and locking front with rear unlocked causes under steer.

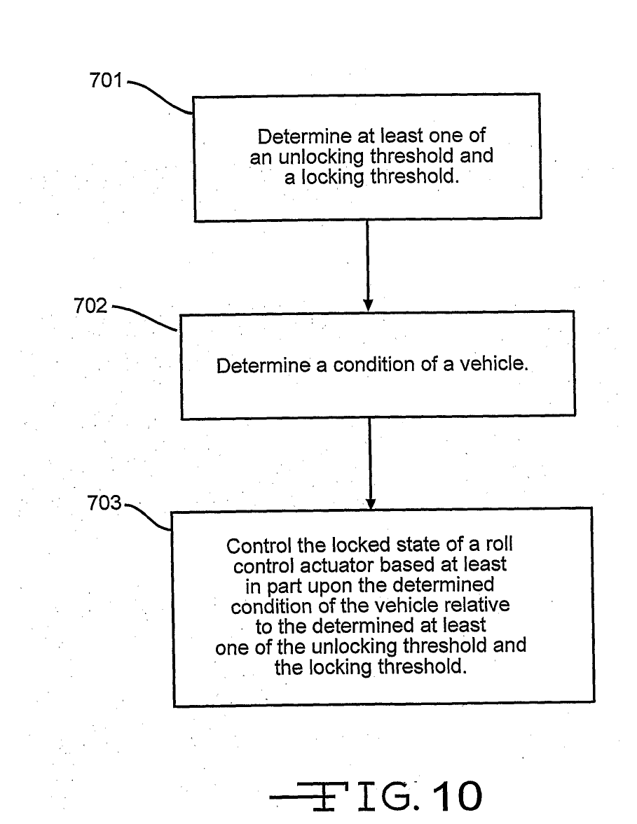

Referring now to FIG. 10, there is illustrated an embodiment of a method for controlling a lockable roll control actuator in accordance with the present invention. The method begins in functional block 701 where at least one of a locking and an unlocking threshold for a lockable roll control actuator is determined. The values of the locking and unlocking thresholds may be derived in any suitable manner such as from lookup tables, or from algorithms. Any suitable input may be used for the determination of the value of locking or unlocking thresholds, such as vehicle speed, road roughness, at least one of deceleration and acceleration of the vehicle, the angular momentum of at least one wheel of the vehicle, steering angle, vehicle load, driving terrain, vehicle implementation (described below), or any other suitable sensed parameter. Further the determination of the value of the locking or unlocking thresholds may be based upon selection of driving mode such as touring driving mode, luxury driving mode, and sports driving mode. The driving mode may be selected manually (e.g., driver input) or automatically.

It must be understood that one vehicle parameter may determine the threshold value of another vehicle parameter at which the roll control actuator will lock or unlock. For example, a locking threshold value for speed of the vehicle (that is, the speed above which a control actuator may be locked) may be based upon the sensed load (weight) carried by the vehicle (vehicle load).

The method continues in functional block 702 where a condition of the a vehicle is determined such as vehicle speed, road roughness, at least one of deceleration and acceleration of the vehicle, the angular momentum of at least one wheel of the vehicle, steering angle, vehicle load, driving terrain, vehicle implementation (described below), or any other suitable sensed parameter.

The method includes a further step depicted in functional block 703 where the locked state of a roll control actuator is controlled based, at least in part, upon the determined condition of the vehicle relative to the determined at least one of the locking threshold and unlocking threshold.

It must be understood that the method may include any suitable number of locking threshold and unlocking thresholds. The locked state of the roll control actuator may be controlled (e.g., the locked state of the actuator may change) based upon one, some, all, or any suitable combination of the thresholds.

Another alternative embodiment of the present invention includes a control strategy in which speed based thresholds may be used to control the roll control actuators. Locking and unlocking thresholds of the actuator(s) can be modified or based upon vehicle speed or speed thresholds. This is beneficial since many other vehicle dynamic responses change with speed, such as steering gain, yaw response etc. Additionally, the hysteresis between locking and unlocking points based on a calculated control variable such as modified lateral acceleration are also often speed dependant.

Another alternative embodiment of the present invention includes a control strategy in which road roughness inputs may be used to control the roll control actuators or used at least in part as a basis for locking and unlocking thresholds of the actuator(s). Upon detection of rough road conditions (e.g. by wheel speeds or chassis accelerometers or wheel displacements or a leveling system), the control parameters for locking/unlocking of the roll control actuators can be modified.

Another alternative embodiment of the present invention includes a control strategy in which manual control may be used to control the roll control actuators. For example, a driver of the vehicle may select the roll control actuators operating thresholds by a driver interface, such as a dashboard switch or other driver interface. It is contemplated that the driver may select a sport mode of control in which the electronic control unit (ECU) controlling operation of the roll control actuators would load an algorithm for high performance driving limiting roll of the vehicle, or another mode of control such as comfort mode, in which the ECU would control the roll control actuators according to an algorithm that increases the comfort of the vehicle ride.

Another alternative embodiment of the present invention includes a control strategy in which the ECU automatically controls the mode of operation or the roll control actuator(s) (i.e., automatic control) based upon the input of sensors and an algorithm to detect, for example high performance driving. For example, the mode may be selected based upon the frequency and magnitude of course adjustment, changes in speed, etc. Locking and unlocking thresholds of the actuator(s) may be based at least in part upon a high performance algorithm.

Another alternative embodiment of the present invention includes a control strategy in which at least one of deceleration and acceleration may be used to control the roll control actuators. For example, upon detection of high deceleration or acceleration actuators may be locked to stiffen corners. In a preferred alternative embodiment, single wheel inputs correspond to respective actuators, i.e. front wheels and front actuator, and rear wheels and rear actuator. Changes in an individual wheel's angular momentum would change the parameters for locking/unlocking a respective actuator. Locking and unlocking thresholds of the actuator(s) may be based at least in part upon an individual wheel's angular momentum. This would provide better contact patch (i.e. traction and braking) performance. For example, deceleration and acceleration control may be controlled under Anti-lock Braking Systems, Traction Control Systems, or Vehicle Stability Control Systems activation.

Another alternative embodiment of the present invention includes a control strategy in which load may be used to control the roll control actuators. For example, an actuator may be unlocked under load as a deliberate action, e.g. during part of fishhook maneuver to dissipate bar energy, through the actuator and roll bar rather than have it put back into the vehicle body at switch over. Locking and unlocking thresholds of the actuator(s) may be based at least in part upon vehicle load. Thus, selectively coupling and uncoupling sprung and unsprung portions of the vehicle.

Another alternative embodiment of the present invention includes a control strategy in which driving terrain may be used to control the roll control actuators. For example, an off road body control strategy, i.e. dynamic unlocking/locking based upon other suspension info such as hub and body corner vertical accelerations, to improve ride better than just for maximum wheel articulation, may be implemented based upon the condition of driving terrain. For example, in such a situation, the actuator may be locked to allow single wheel inputs, to give greater contact patch force in event of slipping wheels. Under this strategy can be tuned for ride or traction and swap as surface changes. Locking and unlocking thresholds of the actuator(s) may be based at least in part upon driving terrain.

Another alternative embodiment of the present invention includes a control strategy in which vehicle implementation or packaging may be used to control the roll control actuators. For example, torsionally deflecting bushings have unique behavior in roll bar support bushings, for example when placed between the roll bar and the chassis frame. There may be some sliding, sticking, or slipping. With larger articulation of the roll control actuators, this may be addressed. One way address this is to use bushings that are stiff radially, but can deflect easily rotationally. Locking and unlocking thresholds of the actuator(s) may be based at least in part upon vehicle implementation.

Another alternative embodiment of the present invention includes a control strategy in which instrumentation/sensor output may be used to control the roll control actuators. For example, algorithms may be implemented which determine locking and unlocking thresholds of the actuator(s) based at least in part upon instrumentation/sensor output of a component of a vehicle, for example, the output of a steering sensor or a vehicle slip control unit. The sprung and unsprung portions of the vehicle may selectively be coupled and uncoupled as a result of the determined thresholds.

It must be understood that embodiments of the invention that include control for the roll control actuators, including the use of the roll control actuators to affect other vehicle aspects and integration with other systems, may include any or all of the system control aspects, and can equally apply for a rotary actuator using any locking/unlocking technology, such as, electrohydraulic, electromagnetic, magneto or electrorheologic actuators.

In accordance with one aspect of the present invention, a hydraulically operated actuator for controlling the roll of a motor vehicle. The actuator is connected between an unsprung portion of the vehicle and a sprung portion of the vehicle for selectively coupling the sprung portion of the vehicle to the unsprung portion of the vehicle. The actuator includes a piston fixed to one of the sprung portion of the vehicle and the unsprung portion of the vehicle and a cylinder fixed to the other of the sprung portion of the vehicle and the unsprung portion of the vehicle. The cylinder has an internal surface defining a bore and at least first and second ports. The piston is disposed in the bore of the cylinder between the first and second ports and sealingly engages the internal surface of the cylinder defining the bore. The first and second ports are connected by a fluid conduit that is one of external to the bore and defined through the piston. A volume of hydraulic fluid is disposed in the bore of said cylinder, such that when flow of the hydraulic fluid between the first port and the second port through the fluid conduit is prevented, the piston can only move in a direction toward a neutral position in the cylinder.

In accordance with another aspect of the present invention, a semi-active system for controlling the roll of a motor vehicle includes a hydraulically operated actuator connected between an unsprung portion of the vehicle and a sprung portion of the vehicle. The actuator includes a cylinder fixed to one of the sprung portion of the vehicle and the unsprung portion of the vehicle. The actuator includes a piston fixed to the other of the sprung portion of the vehicle and the unsprung portion of the vehicle. The cylinder has at least first and second ports and the piston being disposed in the cylinder between the first and second ports. An accumulator is adapted to store a volume of hydraulic fluid. The accumulator is in fluid communication with the first and second ports. A check valve arrangement has an open position and a check position. The check valve arrangement is in communication with the accumulator and the first and second ports of the cylinder for controlling flow of hydraulic fluid between the first port and the second port of the actuator, such that when the check valve arrangement is in the check position the check valve restricts flow between the first port and second port and the piston can only move in a direction toward a neutral position in the cylinder.

In accordance with another aspect of the present invention, a control strategy for a semi-active system for controlling the roll of a motor vehicle in which the vehicle is provided with a roll control actuator connected between an unsprung portion of the vehicle and a sprung portion of the vehicle for selectively coupling and uncoupling sprung and unsprung portions of the vehicle, such that when the actuator is in a locked state, the actuator can only move in a direction toward a neutral position, includes utilizing locking and unlocking thresholds to control the locked state of the actuator.

In accordance with another aspect of the present invention, an actuator for controlling the roll of a motor vehicle is connected between an unsprung portion of the vehicle and a sprung portion of the vehicle for selectively coupling the sprung portion of the vehicle to the unsprung portion of the vehicle, such that when the actuator is in a locked state, the actuator can only move in a direction toward a neutral position.

In accordance with another aspect of the present invention, a semi-active system for controlling the roll of a motor vehicle includes an actuator connected between an unsprung portion of the vehicle and a sprung portion of the vehicle for selectively coupling the sprung portion of the vehicle to the unsprung portion of the vehicle, such that when the actuator is in a locked state, the actuator can only move in a direction toward a neutral position.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A method for controlling a semi-active roll control system of a motor vehicle, the roll control system including a roll control actuator connected between an unsprung portion of the vehicle and a sprung portion of the vehicle for selectively coupling and uncoupling sprung and unsprung portions of the vehicle, the roll control system being arranged such that when the roll control actuator is locked the actuator can only move in a direction toward a neutral position, and when the roll control actuator is unlocked the roll control actuator can move toward or away from the neutral position, the method comprising:
controlling the locked state of the roll control actuator based upon at least one of locking and unlocking thresholds.

2. The method of claim 1 wherein the roll control actuator is a first roll control actuator provided as one of a front and a rear roll control actuator and wherein the vehicle is provided with a second roll control actuator provided as the other of a front and a rear roll control actuator wherein the first and second actuators may be selectively locked and unlocked independently of each other.

3. The method of claim 1 wherein the locking and unlocking thresholds are determined based upon vehicle speed.

4. The method of claim 1 wherein the locking and unlocking thresholds are determined based upon road roughness inputs.

5. The method of claim 1 wherein the locking and unlocking thresholds are manually selectable.

6. The method of claim 1 wherein the locking and unlocking thresholds are determined by a performance algorithm.

7. The method of claim 1 wherein the locking and unlocking thresholds are determined based upon automatic control.

8. The method of claim 1 wherein the locking and unlocking thresholds are determined based upon at least one of deceleration and acceleration of the vehicle.

9. The method of claim 1 wherein the locking and unlocking thresholds are determined based upon the angular momentum of at least one wheel of the vehicle.

10. The method of claim 1 wherein the locking and unlocking thresholds are determined based upon vehicle load.

11. The method of claim 1 wherein the locking and unlocking thresholds are determined based upon driving terrain.

12. The method of claim 1 wherein the locking and unlocking thresholds are determined based upon vehicle implementation.

13. The method of claim 1 wherein the locking and unlocking thresholds are determined based upon at least one of instrumentation and sensors.

14. An actuator for controlling the roll of a motor vehicle, wherein the actuator is connected between an unsprung portion of the vehicle and a sprung portion of the vehicle for selectively coupling the sprung portion of the vehicle to the unsprung portion of the vehicle, such that when the actuator is in a locked state, the actuator can only move in a direction toward a neutral position.

15. The actuator of claim 14 wherein the actuator is a rotary actuator.

16. The actuator of claim 14 wherein the actuator is a hydraulically operated actuator comprising:
a piston fixed to one of the sprung portion of the vehicle and the unsprung portion of the vehicle;
a cylinder fixed to the other of the sprung portion of the vehicle and the unsprung portion of the vehicle, wherein the cylinder has an internal surface defining a bore and at least first and second ports, wherein the piston is disposed in the bore of the cylinder between the first and second ports and sealingly engaging the internal surface of the cylinder defining the bore, wherein the first and second ports are connected by a fluid conduit that is one of external to the bore and defined through the piston; and
a volume of hydraulic fluid disposed in the bore of the cylinder, such that when flow of the hydraulic fluid between the first port and the second port through the fluid conduit is prevented, the piston can only move in a direction toward a neutral position in the cylinder.

17. The actuator of claim 16 wherein the cylinder is fixed to the unsprung portion of the vehicle.

18. The actuator of claim 16 wherein the cylinder includes a small clearance in the bore, through which trapped hydraulic fluid can escape past the piston.

19. The actuator of claim 16, further comprising resilient material disposed within the cylinder, acting to dampen the last portion of travel of the piston in a direction.

20. The actuator of claim 16, further comprising a check valve arrangement, having an open position and a check position, disposed in the fluid conduit between the first port and the second port, the check valve arrangement allowing bi-directional fluid flow between the first port and the second port when the check valve arrangement is in the open position, the check valve arrangement allowing fluid flow from the first port to the second port and preventing fluid flow from the second port to the first port when the check valve arrangement is in the check position, such that the piston con only move in a direction toward the neutral position in the cylinder.

21. The actuator of claim 20 wherein the check valve arrangement comprises a solenoid.

22. The actuator of claim 21 wherein the solenoid energizes the check valve arrangement toward one of the open position and the check position with a force proportional to an electric signal applied thereto.

23. A semi-active system for controlling the roll of a motor vehicle, the system comprising:
an actuator connected between an unsprung portion of a vehicle and a sprung portion of the vehicle for selectively coupling the sprung portion of the vehicle to the unsprung portion of the vehicle, such that when the actuator is in a locked state, the actuator can only move in a direction toward a neutral position;
a sensor of detecting a condition of the vehicle and generating a signal representative of the condition; and,
a controller for selectively locking and unlocking the actuator based at least in part upon the signal.

24. The system of claim 23 wherein the actuator is a hydraulically operated actuator including:
a cylinder fixed to one of the sprung portion of the vehicle and the unsprung portion of the vehicle;
a piston fixed to the other of the sprung portion of the vehicle and the unsprung portion of the vehicle, wherein the cylinder has at least first and second ports, the piston being disposed in the cylinder between the first and second ports;
a fluid conduit providing fluid communication between the first and second ports; and
a valve arrangement disposed in the fluid conduit, the valve arrangement being operated by the controller to selectively prevent fluid flow through the fluid conduit to thereby put the actuator in a locked state.

25. The system of claim 24 further comprising;
an accumulator adapted to store a volume of hydraulic fluid, the accumulator being in fluid communication with fluid conduit; and
wherein the valve arrangement is a check valve arrangement having an open position and a check position, the check valve arrangement being connected in fluid communication with the accumulator and the first and second ports of the cylinder for controlling flow of hydraulic fluid between the first port and the second port of the actuator, the controller controlling the operation of the check valve arrangement such that when the check valve arrangement is in the check position the check valve restricts flow between the first port and second port and the piston can only move in a direction toward a neutral position in the cylinder.

26. The system of claim 25 wherein the actuator is a first roll control actuator provided as one of a front and a rear roll control actuator and wherein the system further includes a second actuator provided as the other of a front and a rear roll control actuator.

27. The system of claim 26 wherein the first and second actuators are controlled independently of each other by the controller and so may be selectively locked and unlocked independently of each other.

28. A method for controlling a lockable roll control actuator, comprising the steps:
a. determining a value of at least one of a locking threshold and an unlocking threshold;
b. determining a condition of a vehicle; and
c. controlling the locked state of a roll control actuator based, at least in part, upon the determined condition of the vehicle relative to the determined value of the at least one of the locking threshold and the unlocking threshold.

29. The method of claim 28, wherein the value of the at least one of the locking threshold and the unlocking threshold is determined based upon at least one of:
vehicle speed;
road roughness;
at least one of deceleration and acceleration of the vehicle;
the angular momentum of at least one wheel of the vehicle;
steering angle;
vehicle load;
driving terrain; and
vehicle implementation.

30. The method of claim 28, wherein the roll control actuator in electrically actuated, the method further including controlling the roll control actuator such that when the condition of the vehicle indicates that the locking threshold is exceeded the actuator only moves toward a neutral position.

31. The method of claim 30, wherein the roll control actuator contains a rheological fluid which when energized locks the roll control actuator.

32. The method of claim 30, wherein step c includes energizing the roll control actuator into a locked state when the locking threshold is exceeded.

33. The method of claim 30, wherein step c includes unlocking the roll control actuator when the condition of the vehicle indicates that the unlocking threshold is not exceeded.

34. The method of claim 28, wherein the roll control actuator is connected between a sprung and an unsprung portion of the vehicle for selectively coupling and uncoupling the sprung and the unsprung portions of the vehicle, the roll control actuator being adapted to move only toward a neutral position when in a locked state, and adapted both toward and away from a neutral position when in an unlocked state, and wherein step c further includes:
unlocking the roll control actuator when the condition of the vehicle indicates that the locking threshold is not exceeded.

35. The method of claim 28, wherein the roll control actuator is connected between a sprung and an unsprung portion of the vehicle for selectively coupling and uncoupling the sprung and the unsprung portions of the vehicle, the roll control actuator being adapted to move only toward a neutral position when in a locked state, and adapted both toward and away from a neutral position when in an unlocked state, and wherein step c further includes:
locking the roll control actuator when the condition of the vehicle indicates that the locking threshold is exceeded.
